(19) United States
(12) Patent Application Publication
(10) Pub. No.: US 2015/0009043 A1
(43) Pub. Date: Jan. 8, 2015

(54) INTERMEDIATE AUDIO LINK AND APPARATUS FOR DEVICE-TO-DEVICE COMMUNICATIONS

(71) Applicant: FitLinxx, Inc., Shelton, CT (US)

(72) Inventors: Thomas Quinlan, Stow, MA (US); Thomas P. Blackadar, Natick, MA (US)

(73) Assignee: FitLinxx, Inc., Shelton, CT (US)

(21) Appl. No.: 14/380,701

(22) PCT Filed: Feb. 21, 2013
(86) PCT No.: PCT/US2013/027011

§ 371 Date: Aug. 22, 2014

Related U.S. Application Data
(60) Provisional application No. 61/602,819, filed on Feb. 24, 2012.

(51) Int. Cl. G08C 23/02; G10L 19/018; H04M 1/725; H04M 11/06; H04W 84/18; A63B 24/00

(52) U.S. Cl. CPC G08C 23/02; H04W 84/18; A63B 24/0062; H04M 1/725; H04M 11/066; G10L 19/018
USPC 340/870.3

(57) ABSTRACT

Low-data-rate device-to-device communications may be established via at least one intermediate audio link Non-audio data may be encoded onto an audio data stream. The audio data stream may be converted to a non-audio data stream, e.g., an RF data stream, for wireless transmission to a second device. The second device may receive the wireless data stream. The second device may further decode a replica of the original non-audio data from the audio stream. Device-to-device communications employing an intermediate audio link may be used for communications between low-processing power devices, e.g., sensors and monitors, and more sophisticated processors, e.g., cell phones, computers, PDA's, tablets. Intermediate audio links may be useful for health and industrial applications. Low-power network protocols may also be used to establish a network of devices that use at least one intermediate audio link.

### RELATED APPLICATIONS

This application claims the benefit of U.S. provisional application Ser. No. 61/602,819 titled “Intermediate Audio Link and Apparatus for Device-to-Device Communications,” filed on Feb. 24, 2012, which is incorporated herein by reference in its entirety.

### FIELD

Apparatuses and methods are disclosed that enable wireless device-to-device communications using an intermediate audio link. More particularly, an intermediate audio link may be used to establish communications between an intelligent activity monitor and another electronic device, such as a cell phone.

### BACKGROUND

In recent years, activity monitors have increased in sophistication, and have evolved from sizable mechanical devices, configured to be supported on a shoe or hip, that could approximate a distance walked or run by an individual. Activity monitors today comprise small digital electronic devices offering increased accuracy and functionality that can be supported at locations on a person other than the foot or hip. Such devices commonly include a microprocessor and one or more accelerometers. Some devices can accurately determine distances walked, or run, calculate pace, and estimate calories burned for the activity.

Many current intelligent activity monitors operate based on machine-readable instructions that were loaded onto the device's microprocessor during manufacture of the device. When used, the activity monitor may record and process data representative of an activity undertaken by a user wearing the activity monitor. The monitor may be configured to download data representative of the activity to a computer at times selected by the user, e.g., when the user connects the device to a computer or places the device in close proximity to a computer to establish a link between the computer and the activity monitor.

### SUMMARY

Apparatuses and methods may be used to automatically establish frequent data communications between two or more intelligent devices using an intermediate audio link. We have recognized that in certain low-data-volume applications, an intermediate audio link or limited bandwidth link does not impose a significant data restriction on communications between devices. Accordingly, technology developed for wireless audio communications may be used in conjunction with an intermediate link to establish electronic communications between two or more devices.

One application that is suitable for using an intermediate audio link is establishing communications between an activity monitor, described above and below, and a portable intelligent electronic device, such as a PDA, tablet computer, smart phone, netbook computer, or laptop computer. We have also recognized that intermediate audio links may be utilized in other systems, such as industrial control systems that may include, for example, programmable logic control (PLC) systems, distributed control systems (DCS), and supervisory control and data acquisition (SCADA) systems. For example, monitoring or sensor devices may be linked to a central controller (e.g., in a master-slave network configuration), or to at least one other monitoring device (e.g., in a peer-to-peer network configuration) via an intermediate audio link.

In some embodiments, two-way communications may be established between a first device and a second device using an intermediate audio link. The first device may, for example, comprise a first circuit configured to encode non-audio data onto a first audio data stream, and a second circuit configured to receive the first audio data stream and convert the audio data stream to a non-audio transmission data stream for wireless transmission to a distant device. In some embodiments, the transmission data stream may be an RF signal as is used for Bluetooth® audio communications between devices.

In some embodiments, an apparatus may comprise an audio encoder configured to encode non-audio data onto a first audio data stream, and a converter configured to receive the first audio data stream and convert the first audio data stream to a non-audio transmission data stream for transmission to a distant device.

Methods for device-to-device communications with an intermediate audio link are also described. In some embodiments, for example, a method for communicating wirelessly between at least a first device and a second device may comprise an act of encoding, by an audio encoder at the first device, non-audio data onto a first audio data stream. The method may further comprise an act of converting, by the first device, the first audio data stream to a non-audio transmission data stream for transmission to the second device.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1A depicts an illustrative example of an intelligent activity monitor 100 supported by a subject 50. In some embodiments, the activity monitor may be supported at locations on the subject other than the foot or ankle;

FIG. 1B depicts examples of components that may be included in an activity monitor such as that shown in FIG. 1A;

FIG. 1C is a block diagram illustrating examples of selected electrical components that may be included an activity monitor such as that shown in FIGS. 1A-B;

FIG. 2 is a block diagram depicting an illustrative embodiment in which two devices are connected via an intermediate audio link;

FIG. 3 depicts an example of how digital data may be encoded and decoded over a communication channel that includes an intermediate audio link;

FIG. 4A illustrates an example of a signal encoding paradigm that may be used for communicating digital data over an intermediate audio link;

FIG. 4B illustrates another example of an encoding paradigm that may be used for communicating digital data over an intermediate audio link;

FIG. 5 illustrates an example of how digital data may be decoded from an audio stream;

FIG. 6 depicts an illustrative example of system of devices that may communicate via a local network that may include at least one intermediate audio link;

FIGS. 7A-7B depicts an example of how multiple devices may communicate within a network, in some embodiments;

FIG. 8A depicts an illustrative example of a process of pairing between a first device and a second device with optional additional data exchange, that may be employed in some embodiments;

FIG. 8B depicts an example of a process for pairing that may be executed by a hub device in a network, in some embodiments; and

FIG. 9 depicts examples of methods of establishing communication between two devices and a central hub that may be employed in some embodiments.

The features and advantages of the present invention will become more apparent from the detailed description set forth below when taken in conjunction with the drawings.

### DETAILED DESCRIPTION

### I. Intelligent Devices Using an Intermediate Audio Link

Various embodiments of apparatuses, methods and systems for establishing device-to-device communications using an intermediate audio link are described in further detail in the following sections. In some embodiments, a data communication link between two or more intelligent devices may include at least one intermediate audio link portion. As used herein, the term “intelligent device” includes any device comprising a processor, a microcontroller, microprocessor, field-programmable gate array, programmable logic circuit, or a combination thereof. At the audio link, non-audio data may be encoded to an audio stream for communication through the audio link portion. The audio stream may then be encoded into a non-audio transmission stream for wireless transmission to a distant device. In some embodiments, the audio link portion may support a lower or higher data rate than other portions of the data communication link.

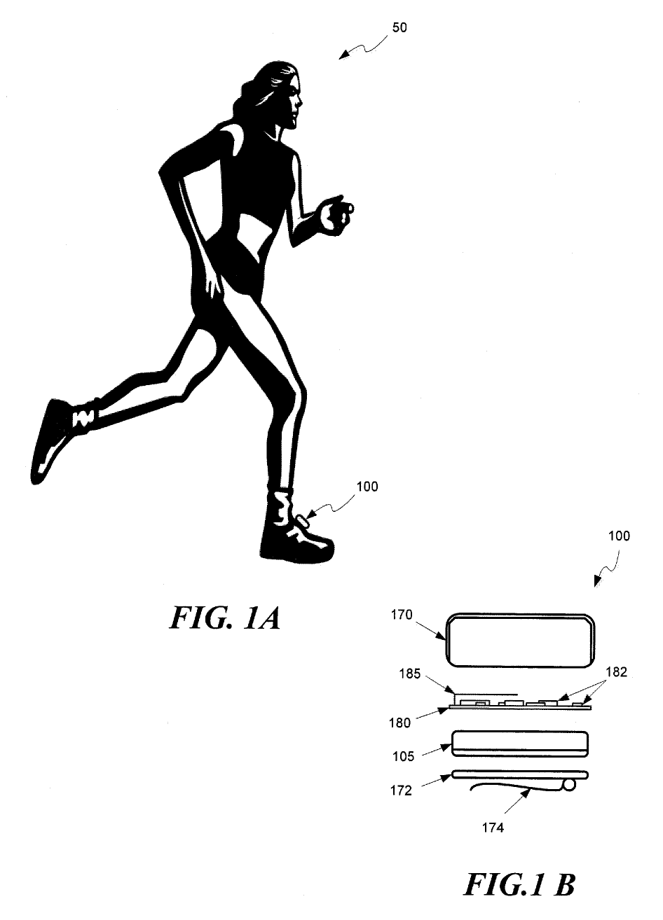

By way of introduction and with reference to FIG. 1A, one example of an intelligent device that may be configured for communication through an intermediate audio link is an activity monitor that may be supported on a subject to monitor one or more in which the subject is engaged. As shown, an intelligent activity monitor 100 may, for example, comprise a small electronic device attached to or supported by a subject 50, and may be configured to identify a type of activity from among a plurality of different activities that may be performed by the subject, and to process data received during an identified activity to calculate one or more parameters representative of the activity. In various embodiments, the subject 50 may be human or non-human, animate or inanimate. In certain embodiments, the activity monitor 100 may be supported by a subject 50 in any suitable manner (e.g., strapped to an ankle or wrist like a watch, or attached to an article of clothing worn by the subject, clipped to a spoke on a wheel) at any suitable location on a subject. In some embodiments, data calculated by the activity monitor may be stored and/or transmitted to a distant device via an intermediate audio link.

There may, in some embodiments, be a wide variety of different activities that can be identified by the activity monitor (e.g., walking, running, biking, swimming, using an elliptical workout machine, rowing, cross-country skiing, performing jumping jacks, performing athletic drills, and jumping rope). In some embodiments, the intelligent activity monitor 100 may additionally or alternatively be configured to identify “fake” or falsified activities, e.g., activities alleged to be human activities that are not common to or not capable of being performed by a human subject 50.

In some embodiments, the intelligent activity monitor may, for example, comprise an accelerometer capable of generating one or more data streams representative of motion of the activity monitor and a programmable microprocessor along with machine-readable instructions operable on the microprocessor to adapt the microprocessor to analyze the one or more data streams to identify the type of activity performed by the subject 50, as well as identify a fake activity, and to process data received during an identified activity. In certain embodiments, the intelligent activity monitor 100 may additionally or alternatively be configured to communicate (e.g., exchange data wirelessly or via a cabled communication port) with a remote or distant device such as a cell phone, PDA, computer, or any type of data-processing device that may be configured in a network of electronic devices. In some embodiments, the intelligent activity monitor may additionally be adapted for low-power operation such that it can operate for days in some embodiments, months in some embodiments, or even years in some embodiments, between recharging or replacement of its power source.

Referring now to FIG. 1B, an exploded view of an illustrative example of an activity monitor 100 supporting an intermediate audio link that may be employed in certain embodiments is illustrated. As depicted in FIG. 1B, the activity monitor 100 may, for example, comprise an enclosure that includes a first cover 170 and second cover 172. The first and second covers may be formed from any suitable materials including, but not limited to, metals and plastics or combinations thereof. As one example, the first cover 170 may be a molded plastic and the second cover 172 a corrosion-resistant metal. The first and second covers may be fastened together by any suitable means to form a water-tight seal and to enclose a power source 105 (e.g., a battery) and electronic circuitry 180 of the activity monitor. As shown, in some embodiments, a clip or strap 174 may be disposed on or attached to a surface of one of the covers so that the activity monitor 100 may be attached to or supported by a subject or machine (e.g., strapped to a wrist, ankle, or appendage, clipped to an article of clothing, strapped or clipped to a movable portion of a machine.)

As shown, the electronic circuitry 180 may comprise a combination of circuit elements 182 disposed on a printed circuit board. In various embodiments, the circuit elements 182 may, for example, include a combination of integrated circuit (IC) chips, application-specific integrated circuit (ASIC) chips, at least one microcontroller or microprocessor, micro-electrical-mechanical system (MEMS) devices, resistors, capacitors, inductors, diodes, light-emitting diodes, transistors, and/or conductive circuit traces, etc. A microcontroller or microprocessor may, for example, coordinate and manage operation of the monitor's electronic circuitry. In some embodiments, the electronic circuitry 180 may further include at least one radio-frequency (RF) antenna 185 for use in sending and receiving RF communication signals.

FIG. 1C depicts in further detail an example embodiment of internal circuitry 102 that may be used in an intelligent activity monitor 100. As shown, the monitor's circuitry may, for example, comprise a source of power 105, e.g., a battery or energy-scavenging chip and a wake-up and power-management circuit 150, that provide and manage power to an accelerometer 130, a microprocessor or microcontroller 110, memory 120, and a transceiver 140. The microcontroller 110 may be coupled to the wake-up circuit, the accelerometer, memory, and the transceiver. The microcontroller may be configured to receive and process acceleration data from the accelerometer 130, to read and write data to memory 120, and to send and receive data from transceiver 140. The wake-up circuit 150 may additionally or alternatively be adapted to sense when the activity monitor 100 is not in use, and in response, reduce power consumption of the internal circuitry 102. In some embodiments, the wake-up circuit may additionally or alternatively be adapted to sense when the activity monitor 100 is placed in use, and in response, activate one or more elements of the internal circuitry 102.

In some embodiments, the microprocessor or microcontroller 110 may, for example, comprise a low-power, 8-bit microcontroller configured to draw low power in sleep-mode operation, and capable of operating at multiple millions of instructions per second (MIPS) when activated. One example of a suitable microcontroller is the 8051F931 microcontroller available from Silicon Laboratories Inc. of Austin, Tex., though any other suitable microcontroller or microprocessor may alternatively be employed in other embodiments. The microcontroller 110 may, for example, include various types of on-board memory (e.g., flash memory, SRAM, and XRAM) for storing data and/or machine-readable instructions, and may be clocked by an internal oscillator or external oscillator. In some embodiments, the microcontroller may, for example, be clocked by an internal high-frequency oscillator (e.g., an oscillator operating at about 25 MHz or higher) when the microcontroller is active and processing data, and alternatively clocked by a low-frequency external oscillator when the microcontroller is substantially inactive and in sleep mode. The clocking of the microcontroller at low frequency may, for example, reduce power consumption by the microcontroller during sleep mode.

In various embodiments, the microcontroller 110 may be configured to receive acceleration data from accelerometer 130 and process the received data according to pre-programmed machine-readable instructions. The microcontroller 110 may, for example, be configured to receive analog and/or digital input data, and may include on-board analog-to-digital and digital-to-analog converters and on-board timers or clocks. In some embodiments, the microcontroller may be further configured to receive power through wake-up and power management circuitry 150. The microcontroller may, for example, cooperatively operate with or comprise a portion of power management circuitry 150, and assist in the activating and deactivating of one or more circuit elements within the activity monitor.

Additional details of components within the activity monitor can be found in U.S. patent application No. 61/566,528, filed Dec. 2, 2011, and titled, “Intelligent Activity Monitoring,” and U.S. patent application Ser. No. 13/690,313 filed Nov. 30, 2012, and titled “Intelligent Activity Monitoring,” the disclosures of which are incorporated by reference herein in their entirety.

As noted above, the described embodiments are not limited to activity monitors. Any type of intelligent sensing and/or data display device that functions with low data rates (e.g., less than about 50 kbit/s in some embodiment, less that about 20 kbit/s in some embodiments, less than about 10 kbit/s in some embodiments, or less than about 5 kbit/s in some embodiments) may, in various embodiments, be adapted to wirelessly communicate to a second device using an intermediate audio link.

### II. Signal Encoding and Decoding

In some embodiments, a transceiver of an intelligent device may be configured to receive data in a first format, e.g., in an audio format from a microcontroller, and process the received data for transmission according to a second format, e.g., a non-audio wireless transmission format, so that the received data may be transmitted to a remote or distant device. Further, the transceiver may additionally or alternatively be configured to receive data according to the second format from a remote or distant device, and process the received data for transmission according to the first format to the microcontroller. According to some embodiments, data from and to memory on the intelligent device may be routed through the microcontroller for processing prior to transmission to or after receipt of data from the distant device. In some embodiments, the link between the transceiver and distant device may, for example, be a Bluetooth link, though any suitable short range wireless link may be used (e.g., any standard protocol such as IEEE 802.1X or a proprietary radio-frequency (RF) link).

In some implementations, the link between the transceiver and distant device may comprise a Bluetooth link adapted for audio communications. In this regard, a transceiver may comprise a Bluetooth audio chip such as the Bluecore® BC6130™ audio chip available from CSR, plc, Cambridge, England (or a similar device, such as Broadcom's BCM2044 chip available from Broadcom Corporation of Irvine Calif.). This chip is a low-cost integrated circuit chip supporting two-way, audio/RF data communications for mobile phone headsets. When used to establish communications between two or more intelligent devices, non-audio data may be encoded at a first device into an audio stream that is provided to the Bluetooth audio/RF chip. The chip may receive the audio stream and convert it to a non-audio transmission stream for wireless transmission to a second device. Further, data can be communicated to the first device from the second device using the same system. We have recognized that one benefit to using a Bluetooth audio/RF chip in an intelligent device is that the chip can make the intelligent device compatible, in terms of data communications, with all commercially marketed cell phones.

Returning to the example of the activity monitor 100 above, in some embodiments, a Bluetooth audio chip may be incorporated in the activity monitor to function as part of a transceiver system for communicating non-audio data (e.g., raw and/or processed data from the accelerometer 130, machine-readable instructions for use by the microcontroller 110, reference values for use by the microcontroller 110, etc.) between the activity monitor 100 and a distant device such as a cell phone, PDA or computer. To enable transmission of data from the activity monitor 100 in the communication link, non-audio data at the activity monitor 100 that is intended for transmission to a second device may, for example, be encoded into an audio format, e.g., an audio stream encoding digital data, that is provided to the Bluetooth audio chip for conversion and transmission to the second distant device. The second device (e.g., a cell phone) may, for example, include an application in software operating on at least one processor, specially adapted hardware, or a combination thereof configured to convert or decode the received data stream to a digital data stream representative of the non-audio data that was originally intended for transmission. Communication in the reverse direction may work similarly. Though the encoding of digital data onto an audio stream may reduce the data rate of communication within the channel, the data rate may be sufficient in many applications where the volume of data exchanged is low and/or data is exchanged infrequently.

We have also recognized that the addition of a Bluetooth audio chip to an activity monitor, sensor, and/or display device can also enable operation of more than one similarly adapted intelligent device in a network. For example, each intelligent device may be configured to communicate with a central hub device (e.g., a cell phone, PDA, computer, tablet, etc.). Further details of networking intelligent devices that may utilize an intermediate audio link in various embodiments are described below.

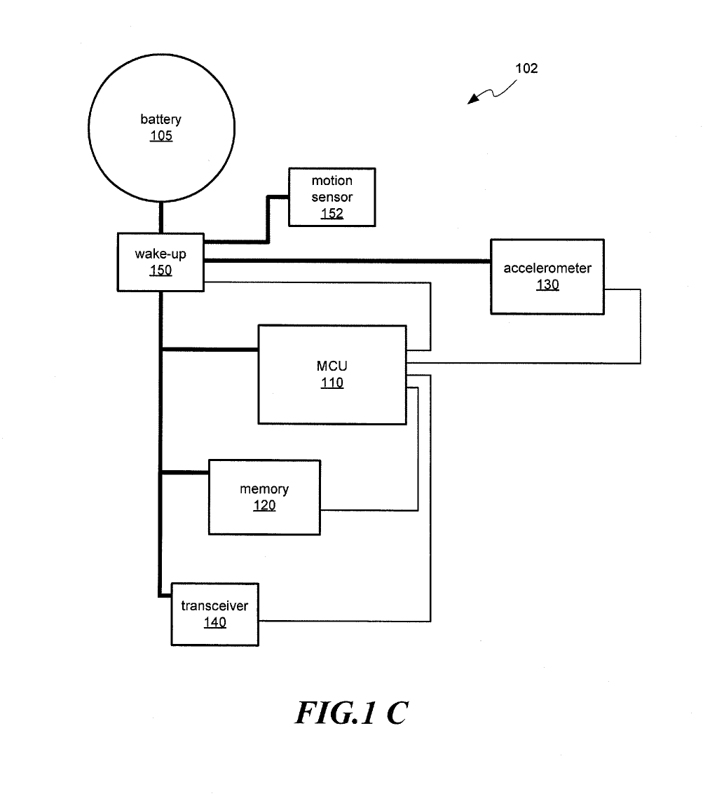

FIG. 2 shows an illustrative example of a system 200 that may be configured to support device-to-device communications over at least one intermediate audio link. As shown, in some embodiments, such a system may comprise a first device 205 and a second device 230. The second device 230 may, for example, be separate and distant from the first device 205. The distance between the first and second device may, for example, be less than about one meter in some embodiments, between about one meter and about 10 meters in some embodiments, between about 10 meters and about 100 meters in some embodiments, and between about 100 meters and about 1000 meters in some embodiments. Each of the devices may, for example, include transceivers supporting wireless (e.g., RF, optical, ultrasonic) communications between the devices. In some implementations, the wireless link between the first device 205 and second device 230 may be limited to a maximum distance lying within any one of the ranges specified above. In such implementations, the second device may be considered a proximal device. Additionally, the wireless link may be a direct link with no intermediary device relaying the communication between the first device and second device, as depicted in FIG. 2.

The first device 205 may, for example, comprise first circuitry 210 that may include sensing elements and/or display or indicating elements. For example, first circuitry 210 may include one or more of any of the following sensing elements: accelerometer, temperature sensor, heart-rate sensor, blood-pressure sensor, hydration sensor, image capture element. The first circuitry 210 may, for example, include one or more of any of the following display elements: LED indicators, alphanumeric display, small video display screen. Further, in some embodiments, the first circuitry 210 may additionally or alternatively include at least one processor 212 (e.g., a microcontroller, microprocessor, DSP chip, field-programmable gate array, or ASIC) that is adapted to encode non-audio data (e.g., digital data representative of a sensed parameter) into an audio format. In some embodiments, the processor 212 may be further used for other functionality in the first circuit 210. In some embodiments, the first circuit 210 may additionally or alternatively include a buffer (not shown) for queuing non-audio data to be encoded. The buffer may, for example, include a cache, a ring buffer, or any other suitable data storage buffer in communication with the at least one processor. Once encoded, the non-audio data may be provided to the transceiver 140 over an audio link 215.

In some embodiments, the first device 205 may additionally or alternatively comprise a transceiver 140 having at least one processor 222 adapted to format and encode the received audio data for transmission over a wireless link, e.g., an RF communication link via antenna 225 to a distant device 230. As described above, transceiver 140 may, for example, comprise a Bluecore® BC6130™ audio chip (or similar device). The distant device 230 may, for example, receive the RF signal via an antenna 235, and first decode the wireless signal to obtain an audio data stream. In some embodiments, the distant device may then use an algorithm and/or specially adapted hardware to decode a digital data stream from the audio stream, wherein the digital data stream is representative of operational data of the first device 205. In some embodiments, the distant device may additionally or alternatively include an algorithm and/or specially adapted hardware configured to decode the digital data stream representative of the operational data directly from the received wireless signal without decoding the intermediate audio stream.

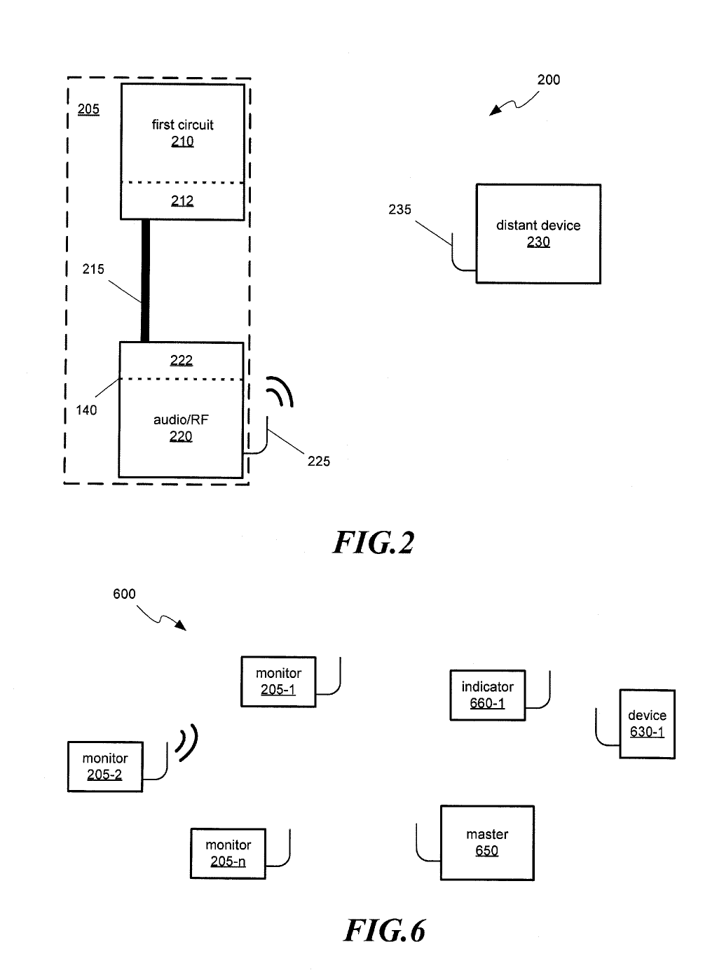

FIG. 3 shows an illustrative example of a method for communicating data between at least two devices (e.g., between devices 205 and 230 in system 200) using at least one intermediate audio link. As shown, in some embodiments, analog or digital data 305 that originates at the first device 205 (e.g., a sensor, indicator, or monitor) and is intended for transmission to a second device 230 may be first encoded 310 onto an audio data stream. Illustrative examples of encoding 310 the digital data onto an audio stream are provided below. The audio stream may, for example, be provided to an audio/RF chip that is adapted to format and encode 320 the audio data stream onto a non-audio wireless transmission data stream that can be transmitted wirelessly from the first device 205 to the second device 230.

In some embodiments, the second device may receive the wireless data stream and decode 330 the received wireless data stream to generate an audio stream. The decoding of the wireless data stream from the first device may, for example, be carried out by an audio/RF chip that may be the type same as, or a different type from, the audio/RF chip used in the first device 205. The audio stream may then be processed further by at least one processor to decode 340 digital data from the audio stream. Illustrative examples of decoding 380 the digital data are described below. Assuming no data is lost or corrupted in the channel, the decoded digital data 306 is an accurate reproduction of original digital data 305. However, in some embodiments, known data recovery or error correction algorithms and techniques (e.g., parity bit, cyclic redundancy check (CRC), checksum, Hamming code, etc.) may be used to tolerate some levels of data transmission errors.

To communicate data originating at the second device 230 to the first device 205, the data or information that is intended for communication may, for example, first be encoded as digital data 307. The digital data 307 may then be encoded 350 onto an audio stream by at least one processor at the second device 230. The audio stream may then be encoded and formatted 360 for wireless transmission to the first device 205 using an audio/RF chip. The first device 205 may receive the wireless data stream and decode 370 an audio stream from the wireless data stream. The first device may further decode 380 the audio data stream to recover digital data 308. Assuming no data is lost or corrupted in the channel, the decoded digital data 308 is an accurate reproduction of original digital data 307. However, known data recovery or error correction algorithms may be used to tolerate some levels of data transmission errors.

In some embodiments, the second device 230 may decode 325 and encode 345 data directly from a received wireless stream to a usable form or from a usable form to a wireless transmission stream without generation of an intermediate audio stream. For example, encoding and decoding software and/or hardware at the second device 230 may be configured to convert data directly from a wireless form to a useable form.

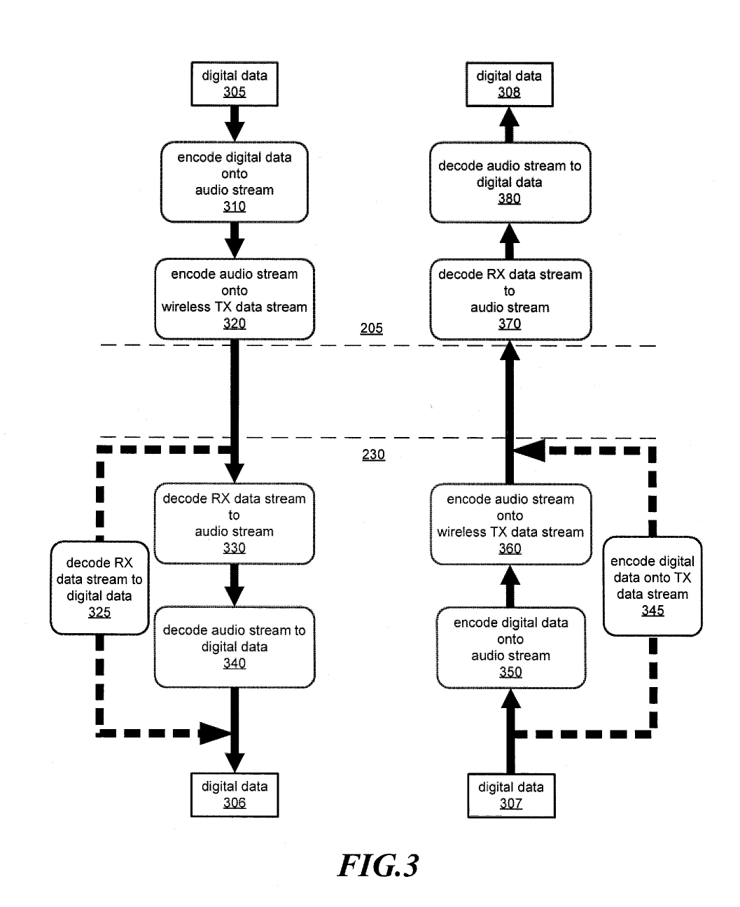

FIG. 4A graphically illustrates one example of encoding digital data 410 onto an audio data stream. As shown, in some embodiments, a digital word consisting of N bits (e.g., 5 bits of digital data 410 in this example) may be converted to a digital data stream 420. The digital data stream may, for example, comprise low and high voltage or current levels corresponding to “0” and “1” bit values output as a sequence over time. In some embodiments, the digital data stream may additionally or alternatively include additional voltage or current levels, e.g., another voltage or current level to indicate that no data is being encoded for transmission.

The digital data stream 420 may be converted to an audio data stream 430 employing frequency-shift keying (FSK) techniques, amplitude modulation (AM) techniques, phase-shift keying (PSK) techniques or any suitable encoding technique. In some implementations, the conversion to audio may be done by applying voltage or current levels from the digital stream to a programmable oscillator to produce a FSK audio stream 430, as depicted in FIG. 4A. For example, a digital low signal on digital data stream 420 may program a programmable oscillator to oscillate at a first frequency 432 for a fixed time interval 440, and a digital high signal on digital data stream 420 may program the programmable oscillator to oscillate at a second frequency 434 for a fixed time interval. The first frequency 432 may be different from the second frequency 434, and both frequencies may be in an audio range (e.g., between about 20 Hz and about 20,000 Hz). As one non-limiting example, the first frequency may be 15 kHz, and the second frequency may be 18 kHz. High audio frequencies (i.e., frequencies at a high-frequency end of the audio range supported by the audio/RF chip) would enable higher data rates than low audio frequencies. In some implementations, the audio stream may include frequencies higher than a human audible range, e.g., between about 20,000 Hz and about 50,000 Hz.

According to some embodiments, a microcontroller 110 or on-board processor may be configured to output an audio stream 430. For example, a microcontroller may include a programmable analog output data port capable of generating analog waveforms representative of audio signals, or digital samples representative of sampled audio signals. The microcontroller or on-board processor may then generate the first and second frequencies 432, 434 for an audio stream corresponding to data bit values that are intended for transmission to a second device.

As will be appreciated from the drawing of FIG. 4A, a received audio stream 430 may be processed to decode digital data 410 from the audio stream. For example, a first received frequency 432 detected within a fixed time interval 440 may be decoded as a first digital value (e.g., a digital “0”), and a second received frequency 434 detected within a fixed time interval 440 may be decoded as a second digital value (e.g., a digital “1”).

FIG. 4B depicts another paradigm for encoding digital data onto an audio data stream. According to this embodiment, the audio data stream 430 comprises substantially square-wave signals 436, 438 of at least two frequencies. The square-wave signals may be produced directly by a microcontroller 110 or on-board processor. For example, the microcontroller may use “bit banging” techniques to generate an audio stream 430 at one of the microcontroller's digital I/O ports. If the microcontroller operates at a data rate higher than the audio range at an I/O port, bits may be tied together to generate the audio stream of an appropriate frequency.

In some embodiments, a square-wave audio stream may be filtered to generate a more sinusoidal-type audio stream prior to providing the audio stream to the audio/RF chip. For example, the square-wave audio stream may be low-pass filtered to remove higher frequency components from the square-wave audio stream. In some implementations, the square-wave audio stream may be provided directly to an audio/RF chip, and the chip itself may naturally filter the input audio stream.

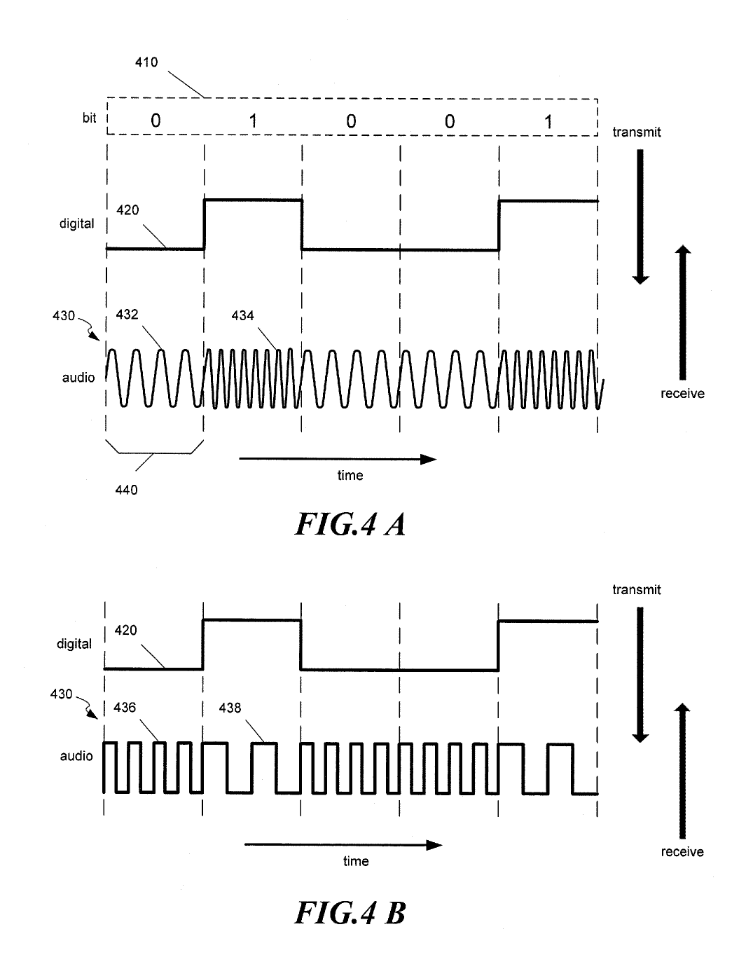

Decoding digital data from an audio stream may be carried out by dedicated hardware and/or a microcontroller 110 or at least one on-board processor. If there is not ample on-board processing power, it may not be possible to implement frequency-detection algorithms that use processor intensive correlation or fast-Fourier transform techniques. An example of a method of decoding digital data from an audio data stream 430 is depicted in FIG. 5. In this implementation, the audio data stream may be substantially a square-wave signal, though any other type and form of cyclical audio signal may be used. Digital data may be encoded in the audio data stream in fixed time intervals 440, as described above. For example, in a first time interval or bit interval 440, a first frequency 436 may represent a logical “0” bit, and in a second bit interval, a second frequency 438 may represent a logical “1” bit. The receiving device may process the audio stream, which may have been decoded from the received wireless data stream, to decode digital values from each fixed time interval of the audio stream.

In some embodiments, a microcontroller 110 or at least one on-board processor may level shift the audio stream 430 as shown in FIG. 5. The level shifting may remove DC components from the audio stream 430. The microcontroller 110 or on-board processor may then sum samples of the audio stream for at least one fixed integration interval 510-1 within the bit interval 440. There may be many samples of the signal within each integration interval 510-1, 510-2, 520-1 (generally referred to as 510 or 520), e.g., more than 16, more than 32, more than 64, more than 128, or even more than 256. The length of the fixed integration interval 510 may be chosen such that the resulting sum of samples for one signaling frequency 436 is approximately zero. (For example, samples representative of areas A1 and A2 cancel each other for the first frequency 436: A1+A2≈0.) If the integration interval 510 is chosen to be a multiple of the duration of the period of the signaling frequency 436, the resulting sum will be independent of the phase of the signaling frequency. The summing over the integration interval 510 may be repeated multiple times within the bit interval 440 to improve signal-to-noise quality.

As can be appreciated, summing over an integration interval 520-1 of the same duration as integration interval 510-1 in a different bit interval 442 containing a different signaling frequency 438 may result in a value that may be greater than or less than zero, depending upon the phase of the signal. (For example, A3+A4≠0.) However, there may be instances where summing over an integration interval 520-2 of the same duration in the different bit interval 442 results in a zero sum value. (For example, A5+A6≈0.) To avoid erroneous detection of the second frequency, summing of samples can be carried out for two integration intervals 520-1, 520-2 that are offset in time or samples by a duration dt or dn. In various embodiments, the duration dt is not a multiple of the period of the second signaling frequency 438. For example, dt or dn may correspond to a fraction of a period of the second signaling frequency. By offsetting the integration intervals 520-1, 520-2, the average value of the square of the two sums will be greater than zero.

Continuing with the above example, a method for decoding digital signal values from an audio stream comprises calculating the following value within each bit interval 440, 442 according to one embodiment.

$$S = {\vert {\sum }_{n = p}^{p + M} \vert}^{2} + {\vert {\sum }_{n = k}^{k + M} {F}_{n} \vert}^{2}$$

where p is a beginning sample number within a bit interval, and M corresponds to the duration of the integration interval 510, 520. k=p+dn, where dn corresponds to a selected offset value as described above. Further, p+dn+M must be a value less than an end value of the bit interval 440. Fₙ represents the level-shifted audio signal. The resulting sum S may be evaluated to determine whether it is approximately zero, or a value greater than zero. In some embodiments, the value S may be compared to a single threshold value, and values falling below the threshold value are assigned a first logic level (bit “0” or “1”), and values falling above the threshold are assigned a second logic level different from the first.

According to some embodiments, level shifting of the audio signal may not be used. Instead, the sum S may be computed directly from the audio stream, and threshold detection may be employed to determine whether the computed sums S represent a first logic level or second logic level (e.g., whether a sum is greater than or less than a predetermined threshold value).

Although the example of decoding the audio signal considers only first and second audio frequencies, as noted above additional audio frequencies may be used to encode additional information. For example, a third frequency may be used to signal that no data is being transmitted, to signal an end of data transmission, or to signal a low-power state of a device. The method of computing a sum and comparing the sum to two threshold values may be used to distinguish more than two audio frequencies. Alternatively, if more processing power is available, Fourier transform or correlation techniques may be used to distinguish between more than two audio frequencies.

### III. Operation in a Network

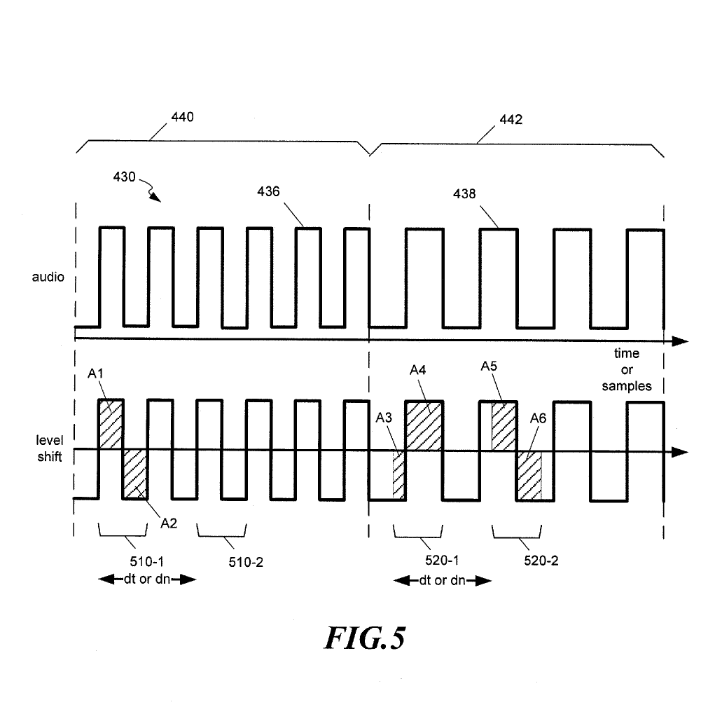

An example of a system of devices configured in a network 600 that supports device-to-device communications via at least one intermediate audio link is depicted in FIG. 6. The system may comprise a plurality of intelligent devices and at least one central hub. As shown, the intelligent devices in the network 600 may, for example, include monitors or sensors 205, at least one device 630, at least one indicator 660 and a master device 650 for managing communications within the network. The monitors 205 may, for example, comprise one or more activity monitors as described above and/or health monitors (e.g., temperature sensor, heart-rate monitor, blood-pressure monitor, glucose monitor, blood oxygenation sensor, respiratory sensor) for fitness or health applications. In some embodiments, the monitors 205 may additionally or alternatively comprise industrial, machine, automotive, or physical plant monitors for industry or apparatus monitoring applications. Communications between any device within the network 600 may be carried out using at least one intermediate audio link.

Device 630 may, for example, comprise an instrument or machine. For example, in a fitness application, device 630 may be a system controller for a bicycle having intelligent electronic monitoring of bicycle-related parameters such as speed, tire pressure, gear, distance traveled, average speed, maximum speed, minimum speed, pedal revolution rate, etc. In a health setting, device 630 may be any health-related instrument: vital signs instrument, intravenous fluid flow meter, EKG machine, spirometer, etc. In an industrial setting or physical plant setting, device 630 may be a controller for any industrial machine, an HVAC controller, elevator controller, fire alarm controller, security alarm controller, etc. Indicator 660 may be any type of indicating device, e.g., a score board, LED light indicators, video display, speaker, PDA, computer, cell phone, vibration motor, meter, etc.

Master device 650 may, for example, be configured to manage network communications. In some embodiments, master 650 may comprise a PDA, computer, cell phone, or the like that is capable of receiving data from and transmitting data to each apparatus 205, 630, 660 in the network. The term “computer” is used herein to refer to any type of computing device, e.g., a PC, laptop, netbook, or tablet. Master device 650 may be combined with another device 630 on the network, and need not be a stand-alone device. In various embodiments, master 650 may access sufficient storage media to store data from all devices with the network 600. According to some embodiments, master 650 establishes communication protocols within the network 600.

In some embodiments, data exchange protocols between any monitor 205, device 630, or indicator 660 and the master 650 may be established according to any of the methods disclosed in U.S. patent application Ser. No. 09/779,900 filed Feb. 8, 2001 and entitled “Intelligent Data Network,” the entire disclosure of which is incorporated herein by reference. For example, master 650 may determine and schedule data exchange intervals during which a monitor 205-n is in an active state for transmission and reception of data and the master is simultaneously in an active state for reception and transmission of data. Data exchange intervals may be unscheduled according to an asynchronous network protocol (e.g., communications established at random times), or may be scheduled according to a synchronous network protocol (e.g., communications established at random times or on a regular repeated basis). Further details of an example of a synchronous network protocol are provided below. During a scheduled data exchange interval data may be exchanged between the master 650 and one device 205-n on the network 600, while other devices on the network are in a power conserving state, or in a state in which they do not attempt communications with the master 650. When there is no data to exchange over the network, all devices may be in a power-conserving state. A power-conserving state may be a state in which a device's transceiver circuitry is inactive and in a low-power or no-power mode. Such communication protocols can conserve power on each device within the network.

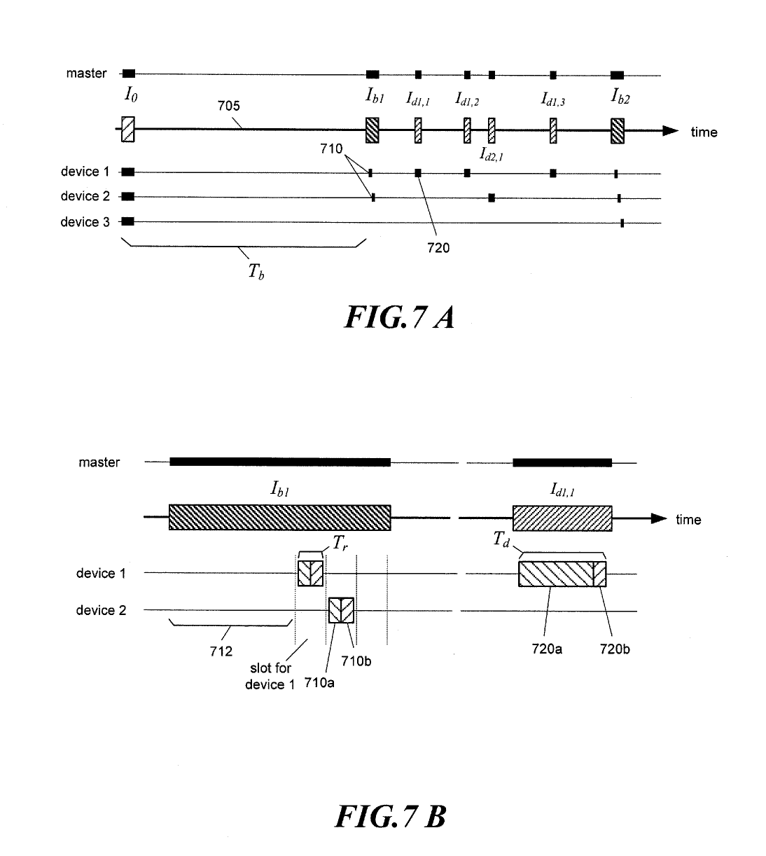

In some implementations, the network 600 may operate according to a dynamic data trafficking protocol. Examples of signaling and timing diagrams for such a protocol are depicted in FIGS. 7A-7B. In some embodiments, the protocol may conform to the power-conserving network protocol described above, but may further assure that there are no data collisions over the network. In some embodiments, the protocol may also dynamically adapt to periods of high and low data traffic.

With reference to FIGS. 6 and 7, master 650 may be responsible for scheduling all data exchange intervals Iₙ for communication. In FIGS. 7A-7B, the thin lines represent passage of time, and the broad bars represent an interval during which the master and one or more devices are in an active communication state, e.g., transceivers are powered up for communicating with another device.

A network initialization procedure may, for example, be carried out during an initialization interval Iₒ when first setting up a network between a master 650 and at least one device 205, 630, 660 on the network. In some embodiments, such a network initialization procedure may, for example, identify the number of devices on the network, determine a device identifier (IDN) for each device on the network, and establish an initial synchronization signal. During the network initialization procedure, all devices on the network may be in an active state and configured to exchange data with master 650. The master may first receive an identification transmission from each device 205, 630, 660 to be configured in the network. The identification transmission may, for example, include the device's IDN and optionally include information about the device (e.g., model, data storage capability, software version, etc.)

In some embodiments, after receiving identification transmissions from each device, the master 650 may transmit to each device, in an initialization transmission that may be broadcast or sent individually to each identified device, a base data exchange (BDX) schedule. Such a BDX schedule may, for example, be static and occur periodically at long time intervals T_{b}, e.g., about once every few seconds in some embodiments, about once every minute in some embodiments, about once every 10 minutes in some embodiments, about once every hour in some embodiments, about once every 10 hours in some embodiments, about once every day in some embodiments, and yet about once every several days in some embodiments. In some embodiments, the BDX schedule may be determined initially by user input to accommodate expected data trafficking rates, but may later be determined by master 650 to meet trafficking needs for the network 600. For example, when data trafficking on the network increases, the master 650 may temporarily increase the BDX frequency to accommodate traffic needs, and then later decrease the BDX frequency to a base rate after a heavy traffic load has subsided.

The BDX schedule may, for example, inform each device 205, 630, 660 as to when the master 650 will be available to receive data transmissions from each device. As depicted in FIG. 7A, the next available data exchange interval I_{b1} may, for example, occur after the initialization interval Iₒ by a time corresponding to the base data exchange interval T_{b}. In some embodiments, the base data exchange interval I_{b} may repeat regularly separated by T_{b}, where I_{b2} represents a subsequent data exchange interval I_{b1} occurring according to the BDX schedule.

In some embodiments, the initialization transmission may additionally or alternatively inform each device 205, 630, 660 as to when it may transmit a request for service 710 within each base data exchange interval I_{b}. The master 650 may, for example, order the requests for service such that multiple requests will not be issued at the same time resulting in a data-exchange collision within the base data exchange interval I_{b}. With reference to FIG. 7B, the requests for service 710 may, for example, comprise two parts: a request definition 710a and a request reply 710b. Each of the request parts may occupy a fixed data exchange interval Tᵣ within the base data exchange interval I_{b}. Each device may or may not issue a request for service during its allotted slot within the base data exchange interval I_{b}.

The request definition 710a may identify the device 205, 630, 660 requesting service, though this may not be necessary in some embodiments. The request definition 710a may also identify the amount of data that the device intends to deliver to the master 650. The master may process the request definition 710a, and schedule a device data exchange interval I_{d} based upon the request. The master 650 may determine, based upon the amount of data in the request, when the device data exchange interval I_{d} is to occur for the device issuing the request for service, and a duration for the data exchange interval T_{d} (or how much data is allowed to be transmitted). Information about the device data exchange interval I_{d} may be transmitted to the device during the request reply 710b.

In some embodiments, the master device 650 may determine when the device data exchange interval I_{d} is to occur for the device based upon the rate of data accumulation at the device. For example, the master 650 may record a first amount of data intended for transmission that is indicated in the service request 710 issued by the device 205, 630, 660. The master 650 may then record a second amount of data that is ready for transmission or received from the device during the following device data exchange interval L_{d1}. The difference between the first and second amounts of data can provide an indication of a rate of data accumulation at the device 205, 630, 660. The master 650 may then schedule a subsequent device data exchange interval I_{d2} based upon the calculated rate of data accumulation at the device. In this manner, the device data exchange intervals I_{d} can be dynamically adjusted by the master 650 in both duration and temporal separation according to data trafficking needs within the network.

As can be seen in FIG. 7A, devices (e.g., device 3) that have no data to communicate can remain in a dormant or ultra-low-power state without communicating with the master 650 until the device has data ready for transmission. In some implementations, to maintain synchronization with the system, a device having no data ready for transmission may “awake” periodically at intervals equal to or longer than T_{b} to receive a synchronization signal from master 650, e.g., during a base data exchange interval I_{b}.

FIG. 7B shows further details of base data exchange interval I_{b}and device data exchange interval I_{d} for devices 1 and 2 of FIG. 7A. As described above, each device in the network may issue a request for service 710 during an interval Tᵣ allotted to the device within the base data exchange interval I_{b}. Each device may have its own slot allotted within the base data exchange interval I_{b}. In some embodiments, guard bands may be used between all data exchange intervals to mitigate data collisions and/or loss of data that may be transmitted before or after a data exchange interval.

In some embodiments, the base data exchange interval I_{b} and device data exchange interval I_{d} may include an initial “device detect” portion 712 during which the master 650 may listen for new devices petitioning to be added to the network 600. The master 650 may receive requests from new devices during this interval, schedule a subsequent data exchange, and transmit information about the subsequent data exchange to the new device so as to silence the new device prior to communicating with existing devices in the network.

As noted above, the device data exchange interval I_{d} may have a length determined by the network master 650, and the length may depend upon how much data is ready for transmission by the device 205, 630, 660. The device data exchange interval I_{d} may include a device data portion 720a and a data reply portion 720b. During the device data portion, the master 650 may be configured to listen for incoming data from the device, and the device may be configured to transmit data ready for transmission. During the data reply portion 720b, the master 650 may be configured to transmit any necessary information (e.g., receipt confirmation, synchronization signal, information about the next scheduled device data exchange interval, software upgrade instructions) to the device, and the device may be configured to listen for a transmission from the master.

Though the above description of network communications in connection with FIGS. 7A-7B relates to a synchronous communication protocol that schedules data exchanges, asynchronous protocols may be used as well in which data exchanges are not scheduled on a periodic basis. In an asynchronous mode, each device 205, 630, 660 may remain in a low power state until the device is ready to transmit data. The device may then power up and transmit a request for service to the master 650. The master 650 may establish communications with the device and accept data from the device. The master 650 may send data and/or instructions to the device in a finite time window after the device concludes its transmission of data to the master. After the finite time window the device may power down to a low-power state for energy conservation. In some implementations, the master may remain in an active listening state to listen for service requests from devices in the network. Further details and examples of asynchronous mode networking can be found in U.S. Pat. No. 7,187,924, filed Feb. 8, 2001, the entire disclosure of which is incorporated herein by reference.

In some embodiments, when data trafficking needs within the network are low and it is unlikely that more than one device will be requesting service or transmitting data at the same time, asynchronous protocols may be employed to reduce device power consumption. According to some embodiments, the master 650 may be configured to switch the network back and forth between synchronous and asynchronous communication protocols, depending upon the trafficking needs of the network 600. For example, at times of low data traffic, the network may be configured by the master 650 for asynchronous communication, and at times of high data traffic, the network may be configured for synchronous communications.

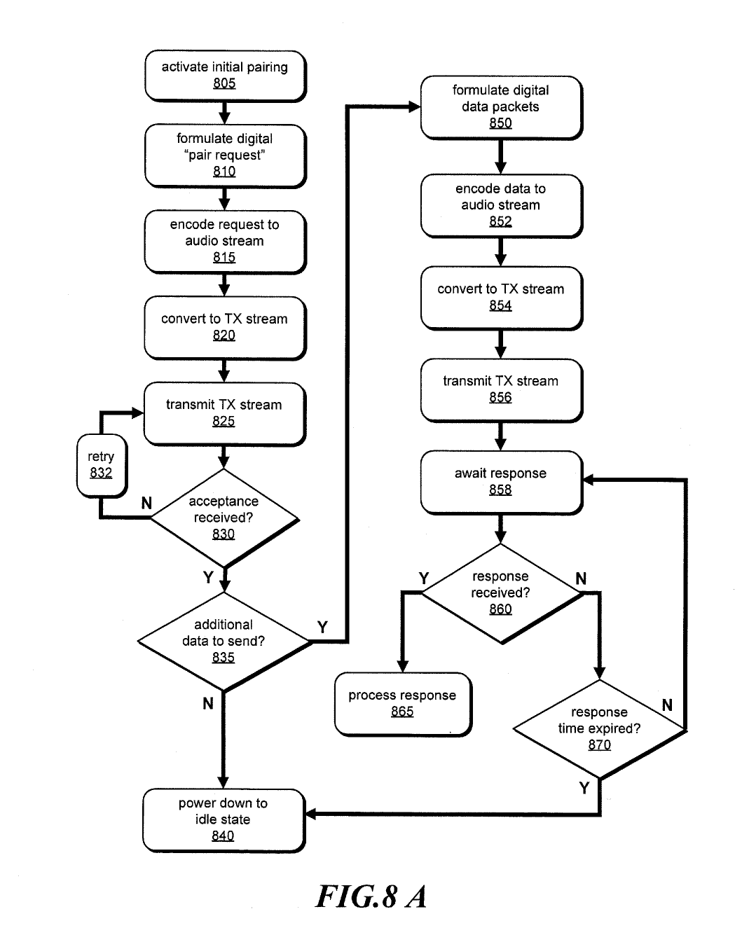

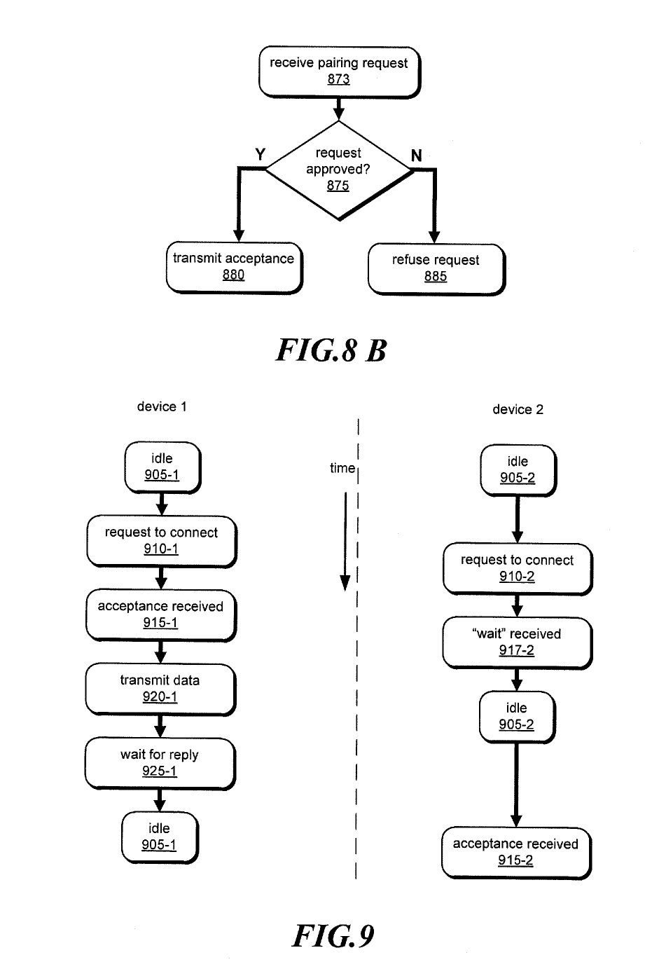

Further details of how a sensor may be operated within a network 600 in some embodiments are provided in connection with FIGS. 8A-8B and 9. FIG. 8A depicts an example of a process that an intelligent device (e.g., activity monitor 205, indicator 660, or device 630) may execute when initially attempting pairing with a master 650 that may serve as a central hub for a network 600 in some embodiments. As shown, in some embodiments, a pairing process between a first device and the master 650 may begin with an activation 805 of initial pairing. There may, for example, be a “pairing” button on the device to initiate pairing, or a tapping or shaking sequence may be used to initiate pairing if the device has motion sensors and is configured to recognize a tapping or shaking “pairing” gesture. In some embodiments, the device may automatically attempt pairing when powered up. There may also be LED indicators on the device that provide visual feedback to assist the user with a first pairing to the master 650. The LED indicators may also be used subsequently to indicate data offloads or downloads at the device.

In various embodiments, the master 650 may be in a pairing mode when pairing requests are issued from a device attempting to connect to a network 600. For example, if a cell phone serves as a master 650, the phone may be placed in a pairing mode manually by a user, or may be configured to enter a pairing mode automatically when a pairing request is received.

Returning to FIG. 8A, the device may formulate 810 a digital “pair request” to be transmitted for establishing pairing between a master 650 and the device. The digital request may include any information necessary to establish pairing with the master. For example, the digital request may include an identification number (e.g., PIN [0000]) that identifies the device to the master 650 for initial pairing. The digital request may include further identification information (e.g., a MAC address) that may be used to distinguish the device from other devices on the network 600. In some embodiments, the digital request may only include a PIN number (e.g., [0000] or [1234]) commonly-used in Bluetooth protocols for pairing audio devices, and the master 650 may assign a MAC address or some other identification to the device during the pairing process.

Once formulated, the request may be encoded 815 onto an audio stream as described above, and subsequently provided to a Bluetooth audio/RF chip to convert 820 the audio stream to a wireless transmission data stream (TX stream). This data stream may be transmitted 825 wirelessly to the master as a request for pairing. The device may then wait 830 for an acceptance response from the master 650 indicating an acceptance of pairing. The waiting for acceptance may be for a predetermined amount of time after which, if no response is received, the device may retry 832 transmitting the request.

If no request is received from the master 650 after a predetermined number of tries, or a predetermined amount of time, then the device may exit (not shown) the initial pairing routine and provide an error indication to the user in the form of a visual, tactile, or audible indication.

If acceptance for pairing is received from the master, the device may process any data sent from the master with the acceptance transmission, and then determine 835 whether the device has additional data to transmit to the master 650. If there is no additional data to transmit to the master 650, then the device may power down 840 to an idle state, which may release the master for communication with other devices on the network. Prior to powering down, the device may or may not send a termination signal to the master to indicate an end of transmission.

If the device determines 835 that there is additional data to send to the master 650, the device may execute data transmission acts 850-856, as shown in FIG. 8A. For example, the data may be formulated 850 into one or more data packets, each with a header identifying the device (e.g., by an assigned MAC address or other identifying data). The packets may each be encoded in an audio stream and converted for transmission as described above.

After transmitting the data, the device may await 858 a response from the master 650. The response from the master may comprises a confirmation that data was received. In some embodiments, the response may include data and/or instructions from the master, e.g., a request to resend some data packets, new data or code to be used by the device, a later time at which communications should be reestablished. If a response is received, the device may process 865 the response and then return to an idle state.

If the device determines 860 that a response has not been received from the master 650, the device may check 870 to determine if a predetermined amount of time allotted for receiving a response from the master 650 has expired. If the allotted time for receiving the response has not expired, the device may continue to await 858 the response. If the allotted time for receiving the response has expired, the device may power down 840 to an idle state. Prior to powering down, the device may or may not send a termination signal to the master to indicate an end of transmission.

FIG. 8B shows examples of acts that may, in some embodiments, be executed by the master 650 during an initial pairing request. As shown, the master 650, having been placed in pairing mode, may receive 873 a pairing request from a device attempting to establish connection to a network 600 to which the master 650 has access. The master 650 may process the received pairing request to determine 875 whether to approve the request. Criteria upon which approval of the request may be based may include any one or combination of the following: PIN number, MAC address, proprietary authentication code, number of devices on the network 600, current network traffic volume, etc.

In some embodiments, the master 650 may, for example, maintain a register of devices permitted to have access to the network. The devices may be identified in the register by any combination of PIN number, MAC address, and proprietary authentication code. Upon receiving a pairing request, the master may parse the pairing request for the pertinent identification information, and then determine whether the identification information matches one or more entries in the register. Acceptance or refusal of the paring request may then be determined based on whether the parsed identification information matches one or more entries in the register.

In other embodiments, the master 650 may additionally or alternatively determine the number of devices on the network 600, and may refuse the pairing request if the number of devices, should the requesting device be added, would exceed a predetermined number that could be supported by the master 650.

Regardless of the criteria that is used, in some embodiments, the master 650 may refuse 885 a request or transmit 880 an acceptance of pairing to the device. As described above, a transmission of acceptance for pair may include additional information to be used by the device, e.g., an assigned MAC address or assigned identification number IDN, information identifying a next time for establishing communication with the master, information identifying a current network configuration, a number of devices currently connected to the network, types of devices currently connected to the network, a synchronization signal, etc. In some embodiments, when refusing 885 a pairing request, the master may transmit a notice of refusal, but in some implementations, the master may not respond to the device when pairing is refused.

After an initial pairing has been established, the device may continue to communicate with the master 650 according to any network protocol described above in connection with synchronous and asynchronous communications. In some embodiments, a device may be dropped or disengaged from a network by the master 650. For example, if a device becomes silent for a predetermined amount of time (e.g., no transmissions within an extended period of time), the master may remove the device from an active network configuration. This may free the network to accept other devices. Removal of the device from an active network configuration may comprise ceasing to listen for the device within a time slot allotted for that device.

FIG. 9 shows an example of how potential data collisions on the network may be handled in asynchronous mode in some embodiments. According to this example, two devices, (device 1 and device 2) may each exit a low-power, idle state 905-1, 905-2 and request connection 910-1, 910-2 to a master 650 at nearly the same time. The master 650 may process the first received request and issue an “acceptance” to the first device and a “wait” to the second device. The first device may receive 915-1 the acceptance and transmit data to the master as described above and depicted in the drawing. After waiting 925-1 for a reply from the master, the first device may return to the idle state 905-1.

The second device may receive 917-2 a “wait” response, which may or may not indicate an amount of time for the device to wait before connection to the master 650 can be established. In some embodiments, the second device may return to an idle state 905-2 for an amount of time while waiting. In other embodiments, the second device may instead remain in a data-transmission-ready state while waiting for an acceptance from the master 650. If an amount of time for the device to wait is specified in the “wait” response from the master, the second device may determine whether to return to an idle state or remain in a transmission-ready state. In some embodiments, the second device may resend a request 910-2 to connect to the master at the end of a waiting period. In some embodiments, the “wait” response may include information about a next available time slot in which the second device may connect with the master to transmit data.

The content of all literature and similar material cited herein, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this specification controls.

The section headings used herein are for organizational purposes only and are not to be construed as limiting the subject matter described in any way.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, and/or methods, if such features, systems, articles, materials, and/or methods are not mutually inconsistent, is included within the inventive scope of the present disclosure.

The above-described embodiments of the invention can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single computer or distributed among multiple computers.

In this respect, various aspects of the invention, e.g., network master 650, devices 605, 630, 660, audio/RF converter, digital/audio encoders and decoders, and networking protocols, may be embodied at least in part as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various embodiments of the technology discussed above. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer, processor, or microcontroller, but may be distributed in a modular fashion amongst a number of different computers, processors, or microcontrollers to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. An electronic device comprising:
a first circuit including an audio encoder that is configured to encode non-audio data onto a first audio data stream; and
a second circuit including a converter configured to receive the first audio data stream and convert the first audio data stream to a non-audio transmission data stream for wireless transmission to a proximal device.

2. The electronic device of claim 1, wherein the first circuit further comprises at least one sensor and circuitry configured to sense activity of a subject.

3. The electronic device of claim 2, wherein the first circuit further comprises an accelerometer and a microprocessor.

4. The electronic device of any of claims 1, wherein the non-audio data comprises data representative of an activity of a subject on which the apparatus is supported.

5. The electronic device of any of claims 1, wherein the second circuit comprises a microprocessor and an RF transceiver.

6. The electronic device of any of claims 1, wherein the second circuit comprises an integrated circuit configured to establish a Bluetooth link between a microphone and/or speaker and the proximal device.

7. The electronic device of any of claims 6, wherein the proximal device comprises a cell phone.

8. The electronic device of any of claims 1, wherein the second circuit is further configured to receive a second non-audio signal from the proximal device and provide a second audio signal representative of the second non-audio signal to the first circuit.

9. The electronic device of claim 8, wherein the first circuit is further configured to receive the second audio signal and execute a function identified by the second audio signal.

10. An apparatus comprising:
an audio encoder configured to encode non-audio data onto a first audio data stream; and
a converter configured to receive the first audio data stream and convert the first audio data stream to a non-audio transmission data stream for transmission to a proximal device.

11. The apparatus of claim 10, wherein the non-audio data comprises a digital data stream.

12. The apparatus of claim 10, wherein the converter comprises an integrated circuit configured for audio communications according to a wireless protocol standard.

13. The apparatus of any of claims 10, wherein the audio encoder comprises a microcontroller.

14. A method for communicating wirelessly between at least a first device and a second device, the method comprising:
sensing, at the first device, a variable parameter and generating non-audio data representative of the sensed parameter;
encoding, by an audio encoder at the first device, the non-audio data onto a first audio data stream; and
converting, by the first device, the first audio data stream to a non-audio transmission data stream for wireless transmission to the second device.

15. A tangible storage device having machine-readable instructions that, when executed by at least one processor, adapt the at least one processor to execute acts of:
receiving non-audio data from at least one sensor, the received non-audio data representative of at least one sensed parameter;
encoding the non-audio data onto a first audio data stream; and
providing the first audio data stream to a converter that converts the first audio data stream to a non-audio transmission data stream for wireless transmission to a second device.

16. A system comprising:
a first device in wireless communication with a second device, wherein the first device is configured to encode non-audio data onto a first audio data stream and convert the first audio data stream to a non-audio transmission data stream for transmission to the second device.
